(19) United States
(12) Patent Application Publication
(10) Pub. No.: US 2003/0005344 A1
(43) Pub. Date: Jan. 2, 2003

(54) Synchronizing data with a capture pulse and synchronizer

(76) Inventors: Sriram M. Bhamidipati, Los Altos, CA (US); Kamal J. Koshy, Sunnyvale, CA (US); Horaira Abu, Sunnyvale, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/896,882

(22) Filed: Jun. 29, 2001

(51) Int. Cl. G06F 1/12

(52) U.S. Cl. 713/400

(57) ABSTRACT

The present invention is in the field of synchronizing data. More particularly, the present invention provides a method, apparatus, system, and machine-readable medium to synchronize data between different clock domains using a capture pulse.

### FIELD OF INVENTION

The present invention is in the field of synchronizing data. More particularly, the present invention provides a method, apparatus, system, and machine-readable medium to synchronize data between different clock domains.

### BACKGROUND

Efficient packet sizes for transactions between a host and a target device may be large. For instance, when a host requests a read from a memory device and the read comprises data from consecutive addresses, the most efficient packet size for the host and memory device may be the entire read since a single transaction may request the data and respond to the request. However, hosts on a bus may transact with a target device on a second bus via a network component and large packets may not be handled efficiently or at all by the network component.

Efficient packet sizes for transactions processed by a network component, such as a bridge, router, hub, switch, etc., may be based on an internal register size of the network component since network component may store transactions in the register. In many cases, the network component may limit the size of a transaction based on the size of the register. For example, when more than one host initiates a transaction to transmit to a target device via a network component, algorithms may factor in the size of the register when arbitrating the bus, determining how to respond to the transaction, and determining when to terminate the transaction. Thus, the network component may force the host and target device to divide a large packet transaction into a sequence of smaller packet transactions.

Forcing the host and target device to transact via a sequence of smaller packet transactions may cause the host, network component, and target device to spend additional time and energy on a transaction. The size of the sequence of smaller packet transactions may be greater than a single large packet transaction as a result of additional data for identification of the transactions for a host, network component, and target device. Further, the time spent processing the sequence of smaller packet transactions may be greater as a result of additional data and handshaking. Thus, small registers can diminish device and bus speed by increasing the amount of traffic and data on a bus.

### BRIEF FIGURE DESCRIPTIONS

In the accompanying drawings, like references may indicate similar elements:

FIG. 1 depicts a host coupled to a target device via a network component.

FIG. 2 depicts four First In, First Out queues, eight bit wide by four bit deep, coupled to synchronous memory.

FIG. 3 depicts a flow chart to synchronize and schedule data for synchronous memory.

FIG. 4 depicts a timing diagram for a synchronizer.

FIG. 5 depicts a machine-readable medium comprising instructions to synchronize and schedule data for synchronous memory.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments. The variations of embodiments anticipated for the present invention are too numerous to discuss individually so the detailed descriptions below are designed to make such embodiments obvious to a person of ordinary skill in the art.

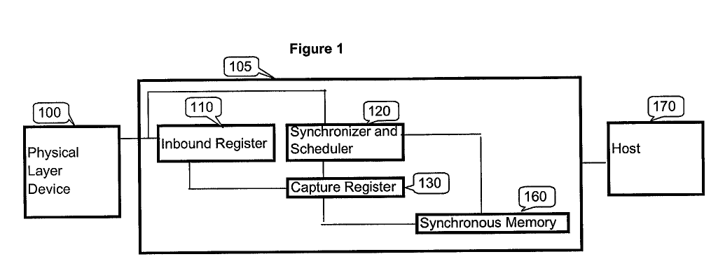

Referring now to FIG. 1, there is shown a host 170 coupled to a physical layer device 100 via a network component 105. The host 170 may comprise an agent on a first bus and may request a large packet transaction of physical layer device 100 via network component 105. The physical layer device 100 may comprise networking products, including media converters, switches, wireless, transceivers, hubs, and print servers supporting Ethernet, Fast Ethernet, asynchronous transfer mode (ATM), and Gigabit Ethernet. Network component 105 may forward the large packet transaction to physical layer device 100 and physical layer device 100 may respond with a large packet comprising data.

Network component 105 may comprise an inbound register 110, a synchronizer and scheduler 120, a capture register 130, and a synchronous memory 160. The inbound register 110 may receive data for a transaction from physical layer device 100 according to a media clock frequency, e.g., the frequency of the bus coupling physical layer device 100 to network component 105 or the frequency of a protocol handling the bus transaction. For example, the bus may be 32 bits wide and the clock speed of the bus may be between 25 and 125 MHz so inbound register 110 may receive 32 bits of data from physical layer device 100 at a rate of 25 to 125 million times per second. Synchronizer and scheduler 120 may receive the media clock signal and receive a memory clock signal for synchronous memory 160. The synchronizer and scheduler 120 can generate a capture pulse to synchronize the media clock signal with the memory clock signal by using asynchronous logic to generate a capture pulse at the first stable rising edge of the memory clock signal after the media clock signal is asserted. The synchronizer and scheduler 120 may be designed to assure a single capture pulse is generated during an assertion of the media clock signal when the media clock signal is a lower frequency than the synchronous memory clock signal. Further, the synchronizer and scheduler 120 may coordinate storage of the data to write to the synchronous memory 160 with capturing data from the inbound register 110 such that data in the capture register is not overwritten prior to writing the data to the synchronous memory 160.

Capture register 130 may be coupled to synchronizer and scheduler 120 to receive capture pulses and coupled to inbound register 110 to capture data. Capture register 130 may capture the data from inbound register 110 at each capture pulse from synchronizer and scheduler 120. Thus, in the present embodiment, capture register 130 may capture 32 bits of data from inbound register 110 on every pulse of the media clock signal, or 25 to 125 million times per second.

Synchronous memory 160 may comprise a memory having a memory word of 32 bits and comprise bytes, kilobytes, megabytes, or gigabytes of memory to store data from inbound register 110. Synchronous memory 160 may be coupled to synchronizer and scheduler 120 to receive a write enable when a memory word is available in capture register 130 to write to synchronous memory 160. Synchronous memory 160 may be coupled to capture register 130 to receive the memory word.

When the bus between network component 105 and host 170 is available for a transaction and host 170 is available to receive a transaction, network component 105 may transfer data stored in synchronous memory 160 in a large packet transaction to host 170. In some embodiments, the last 32 bits of data transferred into inbound register 110 may be transferred from inbound register 110 to host 170 without first being stored in synchronous memory 160.

In alternative embodiments, network component 105 may comprise more than one inbound register 110. For example, when a memory word is 32 bits for synchronous memory 160 and network component 105 comprises two inbound registers to receive a large packet transaction from physical layer device 100, each inbound register may transmit 16 bits of data to a capture register. In some embodiments, each inbound register is coupled to an independent capture register and each capture register may capture 32 bits of data. Further, when network component 105 comprises four inbound registers each register may transmit eight bits of data to a capture register or each inbound register may be coupled to an independent capture register.

In other embodiments, network component 105 may comprise a multiplexer and separate the synchronizer and scheduler functions. When network component 105 comprises more than one capture register, each capture register may be coupled to the multiplexer. The scheduler may be coupled to a synchronizer or a synchronizer for each capture register to determine a write select signal to transmit to the multiplexer to select each capture register in a sequence. The sequence may also be based upon the number of ports available to write data to the synchronous memory. When a capture register is selected by the scheduler, the data in the capture register may be written to the synchronous memory 160. The scheduler may also coordinate the transfer of data from each capture register into the synchronous memory to prevent a data overflow in a capture register. This coordination may be more complex when the more than one inbound register receives data at more than one media clock frequency.

In some embodiments, the scheduler may track the number of capture pulses received by each capture register and determine when the capture register is full and should be drained to the synchronous memory. Many these embodiments comprise a capture register that captures a partial or full memory word from an inbound register each capture pulse. In some of these embodiments, the capture pulse is generated every clock signal of the lower frequency between the media clock signal and the memory clock signal.

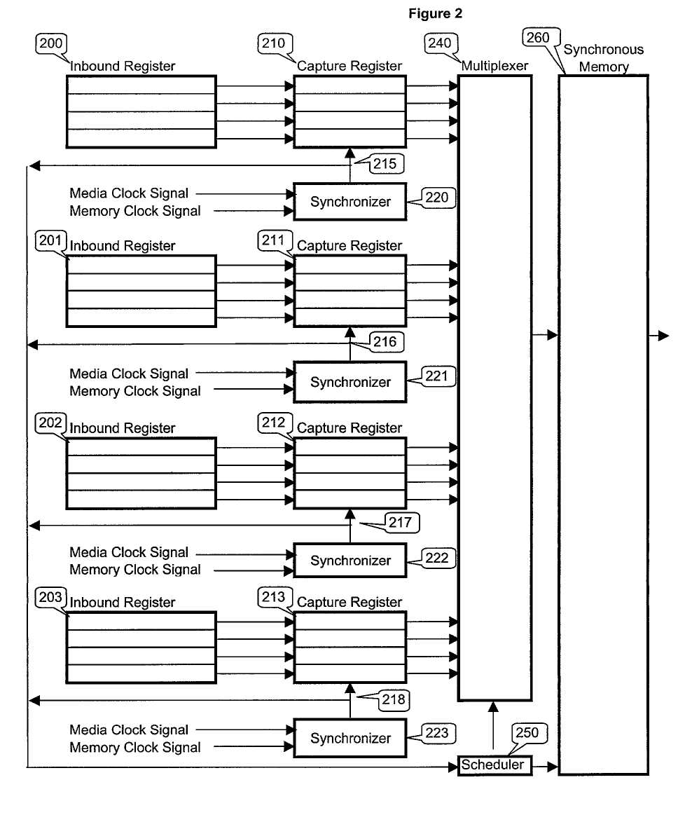

Referring now to FIG. 2, there is shown an apparatus comprising four inbound registers 200, 201, 202, and 203 coupled to a synchronous memory 260. Each inbound register 200, 201, 202, and 203 may receive one-fourth of a memory word of each media clock cycle. A synchronizer 220, 221, 222, and 223 for each inbound register 200, 201, 202, and 203 may receive a media clock signal and receive a memory clock signal for synchronous memory 260. The synchronizers 220, 221, 222, and 223 may generate a capture pulse, synchronizing the media clock signal with the memory clock signal, to capture data from inbound registers 200, 201, 202, and 203. For example, synchronizer 220 may generate a capture pulse at a transition of the memory clock signal when the media clock signal is asserted. The synchronizer 220 may comprise an asynchronous state machine to generate the capture pulse when the memory clock signal has a rising edge. This capture pulse can be the first rising edge of the memory clock signal after the last rising edge of the media clock signal since the last rising edge of the media clock signal may show that the data is ready. The asynchronous state machine may not create a capture pulse when one or both signals may be unstable. For instance, during a transition from low to high, a reading of the state of the signal can fluctuate and the asynchronous state machine can be designed to ignore a reading when the signal is unstable. When synchronizer 220 generates a capture pulse 215 the capture pulse is transmitted to the capture register 210.

Capture register 210 may capture data from inbound register 200 for each capture pulse 215 input from synchronizer 220. The capture pulse 215 from synchronizer 220 may also be forwarded to scheduler 250. Further, when capture register 210 comprises data, the data may be forwarded to multiplexer 240 when multiplexer 240 receives a write select from scheduler 250. Inbound registers 201, 202, and 203 may operate in a similar fashion with synchronizers 221, 222, and 223 and capture registers 211, 212, and 213. Each synchronizer 220, 221, 222 and 223 may forward a capture pulse 215, 216, 217 and 218 to scheduler 250 when the capture pulses are generated.

Scheduler 250 may receive capture pulses from synchronizers 220, 221, 222, and 223 and select a capture register 210, 211, 212 or 213 to drain to synchronous memory 260 via multiplexer 240. Scheduler 250 may comprise an output of a write select to multiplexer 240 and an output of a write enable to synchronous memory 260 to allow data of a capture register 210, 211, 212, or 213 to be written to synchronous memory 260. The write select may indicate the capture register to drain and may be designed to drain a capture register before a full capture register attempts to capture data. The design can consider the configuration of registers such as the frequency of the memory clock signal, the frequency of each media clock signal, and the size of each capture register.

Synchronous memory 260 may comprise an amount of data storage to optimize data flow through the apparatus. For example, when the apparatus is a network component the network component may handle one or more transactions at a time of a maximum size or typical size and synchronous memory 260 may be designed to hold the one or more transactions of a typical or maximum size. In some embodiments, synchronous memory 260 may be coupled to an outbound register or outbound registers. In many of these embodiments, the outbound register configuration may be similar to that of the inbound register configuration to output the data in a similar configuration, such as a large packet transaction of the same or different clock signal.

In alternative embodiments, the number of inbound capture registers and synchronizers may vary. For example, when a memory word synchronous memory 260 is 64 bits, each inbound register may comprise 64 bits and comprise one channel by 64 bits, two channels by 32 bits, four channels by 16 bits, or eight channels by 8 bits. On the other hand, when a memory word is 32 bits there may be one, two or four inbound registers each comprising 32 bits and one channel by 32 bits, two channels by 16 bits, or four channels by 8 bits, respectively. When the incoming data is configured one channel by one memory word, two channels by one half a memory word, or four channels by one fourth of a memory word, data may be drained from a capture register every cycle, every two cycles, or every four cycles of the media clock signal. In some of these embodiments, the capture pulse may capture data from the inbound register(s) every cycle, while in other embodiments, the capture register may also capture data at every cycle, every two cycles, or every four cycles of the media clock signal.

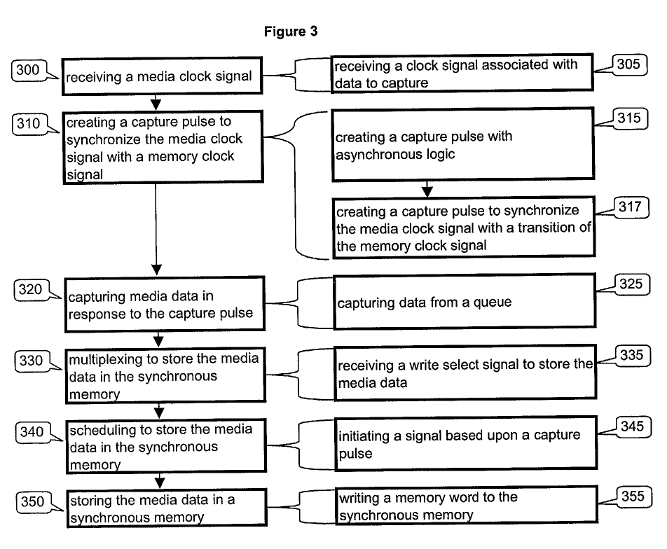

Referring now to FIG. 3, there is shown a flow chart to synchronize and schedule data for synchronous memory. The flow chart comprises receiving a media clock signal 300, creating a capture pulse to synchronize the media clock signal with a memory clock signal 310, capturing media data in response to the capture pulse 320, multiplexing to store the media data in the synchronous memory 330, scheduling to store the media data in the synchronous memory 340, and storing the media data in a synchronous memory 350. Receiving a media clock signal 300 may comprise receiving a clock signal associated with data to capture 305. Receiving a clock signal associated with data to capture 305 may receive a clock signal of a bus or port to capture data from the bus or port in the inbound register. Receiving a media clock signal 300 may comprise receiving a clock signal of a lower frequency than a memory clock signal associated with a synchronous memory.

Creating a capture pulse to synchronize the media clock signal with a memory clock signal 310 may synchronize the media clock signal with a memory clock signal for synchronous memory to facilitate storing data received at a frequency of the media clock signal in the synchronous memory. Creating a capture pulse to synchronize the media clock signal with a memory clock signal 310 may comprise creating a capture pulse with asynchronous logic 315 and creating a capture pulse to synchronize the media clock signal with a transition of the memory clock signal 317.

Creating a capture pulse with asynchronous logic 315 may comprise forwarding the media clock signal and the memory clock signal to a microprocessor executing software comprising asynchronous logic or forwarding a media clock signal and the memory clock signal to an asynchronous state machine. When the asynchronous logic is executed on a microprocessor, the execution of the asynchronous logic is a pseudo asynchronous operation since the microprocessor may operate off a synchronous clock. So the speed of the microprocessor can be designed to appear asynchronous for he purposes of implementing the asynchronous logic. The asynchronous logic implemented by the microprocessor or the asynchronous state machine may comprise two inputs, three internal states, and an output state. In particular, in some embodiments, the asynchronous state machine may be a 3 bit asynchronous state machine. For example, the asynchronous state machine may receive a media clock signal (X) and a memory clock signal (Y) as inputs. A first state (particular values of Q2, Q1, and Q0) may indicate when a media clock signal pulse has been received but a memory clock signal pulse has not been received and may be a function of the inputs X and Y as well as the prior value of Q0 and another state such as the second state and the third state. A second state (particular values of Q2, Q1, and Q0) may indicate when both X and Y are being received this cycle and may be a function of a prior value of Q1 as well as X and Y and another state. A third state (particular values of Q2, Q1, and Q0) may indicate that X has been received and Y was received last cycle but Y is not asserted this cycle. Q3 may be a function of a prior value of Q2, and the state of X, Y and another state. Finally, an output of the capture pulse may be determined as a function of Q0, Q1, and Q2. An example of such logic can be see below:

Q2⁺Q2·X+Q2·Y+Q1·Y

Q1⁺=Q0·XQ1·X+Q2·Q1·Q0+X·\overline{Y}

Q0⁺=Q1·Q0+Q2·\overline{Y}+Q2·\overline{Q1}

Z=Q2·\overline{Q1}+Q2·\overline{Q0}

Creating a capture pulse to synchronize the media clock signal with a memory clock signal 310 may further comprise creating a capture pulse when a partial or full memory word of data is available in an inbound register to capture. In alternate embodiments, more or less states may be tracked in generating a capture pulse along with values to define the states.

Creating a capture pulse to synchronize the media clock signal with a transition of the memory clock signal 317 may create a capture pulse when the media clock signal is high and when the memory clock signal transitions from low to high or high to low. In some embodiments, creating a capture pulse to synchronize the media clock signal with a transition of the memory clock signal 317 may comprise creating a capture pulse after a rising edge of the media clock signal, not yet followed by a capture pulse, and the memory clock signal comprises a stable rising edge from low to high.

Capturing media data in response to the capture pulse 320 may comprise capturing data from a queue 325. Capturing data from a queue 325 may capture data from an inbound register in a capture register. Capturing data from an inbound register may comprise capturing a full or partial memory word from the inbound register when the full or partial memory word becomes available in response to the capture pulse. In some embodiments, capturing media data in response to the capture pulse 320 may comprise capturing data at a first stable transition from low to high or high to low of the capture pulse.

Multiplexing to store the media data in the synchronous memory 330 may comprise receiving data from one or more capture registers, selecting the capture register to receive data from and in response to a write select, and transmitting the data to the synchronous memory. Multiplexing to store the media data in the synchronous memory 330 may comprise receiving a write select signal to store the media data 335. Receiving a write select signal to store the media data 335 may receive a write select from a scheduler to choose a capture register to drain data.

Scheduling to store the media data in the synchronous memory 340 may comprise initiating a signal based upon a capture pulse 345. Initiating a signal based upon a capture pulse 345 may comprise initiating a write select signal and transmitting the signal to a multiplexer to select one or more capture register from which the multiplexer can receive data. Selecting the capture register from which the multiplexer can receive data may also comprise determining the capture register having data available to transfer to the multiplexer. Data in the capture register may be available to transfer to the multiplexer when the data comprises a full or partial memory word. In some embodiments, a full memory word may comprise 32 bits.

Initiating a signal based upon a capture pulse 345 may further comprise transmitting a write enable to the synchronous memory to store the media data in the synchronous memory. In some embodiments, the synchronous memory may operate like a first in, first out queue or more than one queue. Initiating a signal based upon a capture pulse 345 may initiate a write select signal to select a capture register and to transfer data from the capture register to the synchronous memory in a sequential order. For example, when there are four capture registers, data may be captured by the capture register every fourth cycle of the memory clock signal. On the first cycle of the memory clock signal, data in a first capture register may be stored in the synchronous memory. On a second cycle of the memory clock signal, media data in the second capture register may be stored in the synchronous memory, and in the third and fourth cycles of the memory clock signal, data from the third and fourth capture registers may be stored in the synchronous memory. Further, on the fifth cycle of the memory clock signal, the sequence may begin again at the first capture register when data remains to be transferred from the capture registers to the synchronous memory. In alternate embodiments, data may be written to the synchronous memory from the capture registers when the register becomes full wherein a sequential order can be based on the amount of data in a capture register and the number of synchronous memory ports may be available to drain the capture registers.

Storing the media data in a synchronous memory 350 may comprise writing a memory word to the synchronous memory 355. Writing a memory word to the synchronous memory 355 may comprise writing a 32 bit media data in a capture register to synchronous memory. Storing the media data in a synchronous memory 350 may further comprise receiving a write enable from a scheduler and storing data from a multiplexer in memory. In some embodiments, storing the media data in synchronous memory further comprises incrementing a pointer in synchronous memory.

In alternative embodiments, data may be transferred directly from a capture register into synchronous memory in response to a capture pulse. For instance, when a single capture register may transfer data into the synchronous memory, multiplexing may not be necessary.

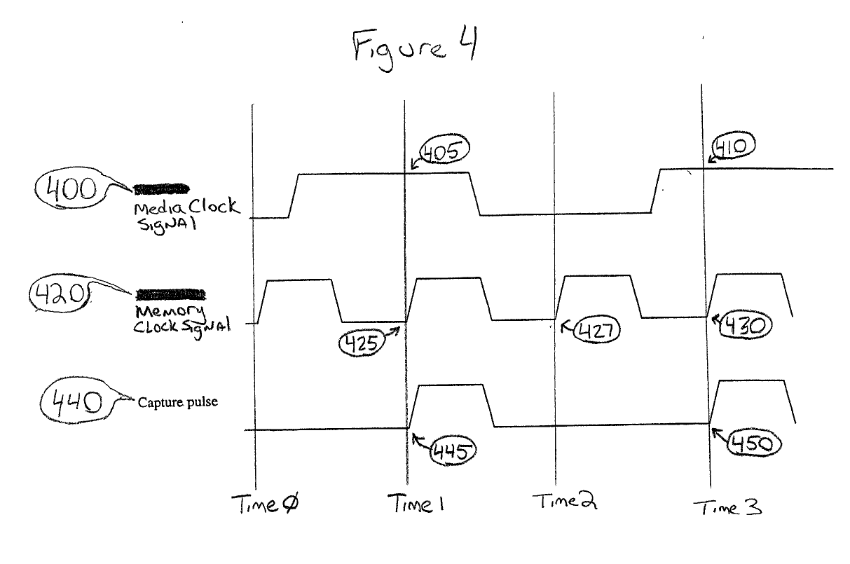

Referring now to FIG. 4, there is shown a timing diagram comprising media clock signal 400, memory clock signal 420, and capture pulse 440. Media clock signal 400 may be a clock signal received along with media data, such as a bus clock signal, to facilitate transferring data from a bus into a register or queue.

Memory clock signal 420 may be a clock signal for synchronous memory such as static random access memory (SRAM). The memory clock signal 420 may indicate how often the synchronous memory can receive data in each available port and output data from each available port.

A synchronizer may receive the media clock signal 400 and the memory clock signal 420 as inputs and output a capture pulse 440. The capture pulse 440 in FIG. 4 may be one possible embodiment of the generation of such a capture pulse. In the present embodiment, the synchronizer is designed to generate or create a capture pulse at the first stable edge of a transition from low to high 425 and 430 of a memory clock signal 420 when the media clock signal 400 is asserted 405 and 410. At time 1, the media clock signal 400 is asserted 405 at a stable rising edge 425 of memory clock signal 420 so a capture pulse 445 is created. At time 2, a capture pulse may not be created because one capture pulse has already been created after the rising edge of the last media clock. At time 3, since a capture pulse has not been generated since that last stable edge of the media clock signal 400, a second capture pulse 450 may be created as a result of asynchronous logic in the synchronizer, recognizing a first stable edge of memory clock signal 420 at 430.

In alternative embodiments, more than one memory clock signal pulse such as pulse 427 at time 2 may occur between capture pulses 445 and 450. In some embodiments, capture pulses 440 may occur at every memory clock signal pulse such as 425, 427 and 430, depending upon the frequencies of the media clock signal and memory clock signal.

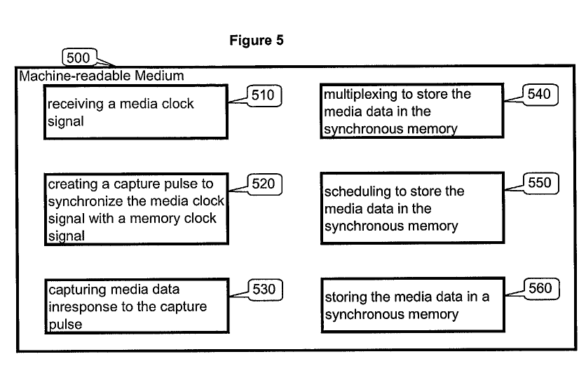

Referring now to FIG. 5, a machine-readable medium embodiment of the present invention is shown. A machine-readable medium includes any mechanism that provides (i.e. stores and or transmits) information in a form readable by a machine (e.g., a computer), that when executed by the machine, can perform the functions described herein. For example, a machine-readable medium may include read only memory (ROM); random access memory (RAM); magnetic disk storage media; optical storage media; flash memory devices; electrical, optical, acoustical or other form of propagated signals (e.g. carrier waves, infrared signals, digital signals, etc.); etc . . . Several embodiments of the present invention can comprise more than one machine-readable medium depending on the design of the machine.

The machine-readable medium 500 may comprise instructions for receiving a media clock signal 510, creating a capture pulse to synchronize the media clock signal with a memory clock signal 520, capturing media data in response to the capture pulse 530, multiplexing to store the data in the synchronous memory 540, scheduling to store the media data in the synchronous memory 550, and storing the media data in a synchronous memory 560. Receiving a media clock signal 510 may comprise instructions for receiving a clock signal used to transfer data into an inbound register. In some embodiments, the clock signal can be used to transfer data from a port of one frequency to a port of a second frequency.

Creating a capture pulse to synchronize the media clock signal with a memory clock signal 520 can comprise comparing a media clock signal to a memory clock signal and determining a pulse to synchronize data associated with the media clock signal to the memory clock signal. Creating a capture pulse to synchronize the media clock signal with a memory clock signal 520 may comprise instructions to output a capture pulse at the coincidence of an event of the media clock signal with a second event of the memory clock signal. In some embodiments, the event on the media clock signal may comprise a transition in the media clock signal and the second event of the memory clock signal may comprise a high state, a low state, or a transition. In embodiments where the media clock signal is faster than the memory clock signal, the event on the media clock signal may be a transition and the event on the memory clock signal may be a high or a low. In other embodiments, when the memory clock signal is faster than the media clock signal, the second event of the memory clock signal may be a transition and the even ton the media clock signal may be an assertion such as high or low.

Capturing media data in response to the capture pulse 530 can comprise instructions for copying the contents of an inbound register into the capture register upon receipt of the capture pulse. In some embodiments, capturing media data in response to the capture pulse 530 may also comprise instructions to capture the media data in response to the capture pulse when the media data comprises a partial or full memory word. In many embodiments, asynchronous logic may determine when to create a capture pulse when the media clock signal event and memory clock signal event are not too close together to obtain a stable and correct transition from one state in the asynchronous logic to a second state.

Multiplexing to store the data in the synchronous memory 540 can comprise instructions for selecting an input to receive captured media data from and outputting the media data to the synchronous memory. Multiplexing to store the data in the synchronous memory 540 may further comprise receiving a signal indicating an input to select.

Scheduling to store the media data in the synchronous memory 550 may comprise instructions for receiving one or more capture pulse from one or more synchronizer, determining the capture pulse associated with a capture register comprising data available to transfer to synchronous memory, outputting a write select signal, and outputting a write enable signal. Outputting a write select signal can comprise instructions to output a signal to a multiplexer to indicate an input for the multiplexer to drain data. Outputting a write enable signal can comprise instructions to output a signal to the synchronous memory substantially simultaneously with outputting a write select signal to the multiplexer.

Storing the media data in a synchronous memory 560 can comprise instructions to receive data from a multiplexer and store the data in memory when a write enable signal is received from a scheduler. In other embodiments, instructions for storing the media data in a synchronous memory 560 can comprise instructions to cause a synchronous memory to store data upon receiving a write enable signal from a scheduler.

In alternative embodiments, instructions for multiplexing to store the media data in the synchronous memory 540 may be unnecessary. In many of these embodiments, storing the media data in a synchronous memory 560 can comprise storing media data from a capture register in synchronous memory in response to a capture pulse. In particular, storing the media data in a synchronous memory 560 can comprise storing media data in response to a write enable signal from a synchronizer. Further, the synchronizer may output a write select signal substantially simultaneously with outputting a capture pulse to a capture register.

What is claimed is:

1. A method, comprising:
receiving a media clock signal;
creating a capture pulse to synchronize the media clock signal with a memory clock signal;
capturing media data at a transition of the capture pulse; and
storing the media data in a synchronous memory.

2. The method of claim 1 further comprising scheduling to store the media data in the synchronous memory.

3. The method of claim 2 wherein scheduling to store the media data comprises initiating a signal based upon a capture pulse.

4. The method of claim 1 further comprising multiplexing to store the media data in the synchronous memory.

5. The method of claim 4 wherein multiplexing to store the media data comprises receiving a write select signal to store the media data.

6. The method of claim 1 wherein said receiving a media clock signal comprises receiving a clock signal of a queue comprising data to capture.

7. The method of claim 1 wherein said creating a capture pulse to synchronize the media clock signal comprises creating a capture pulse with asynchronous logic.

8. The method of claim 1 wherein said creating a capture pulse to synchronize the media clock signal comprises creating a capture pulse to synchronize the media clock signal with a transition of the memory clock signal.

9. The method of claim 1 wherein said capturing data at a transition of the capture pulse comprises capturing data from a queue.

10. The method of claim 1 wherein said storing the data in a synchronous memory comprises writing a memory word to the synchronous memory.

11. An apparatus, comprising:
a synchronizer; and
a buffer coupled to said synchronizer; and
a synchronous memory coupled to said buffer.

12. The apparatus of claim 11, further comprising a multiplexer coupled to more than one buffer.

13. The apparatus of claim 11, further comprising a scheduler coupled to said synchronous memory.

14. The apparatus of claim 11, further comprising an inbound register coupled to said buffer.

15. The apparatus of claim 11, wherein said synchronizer comprises an asynchronous state machine.

16. The apparatus of claim 11, wherein said buffer comprises a buffer to capture data from an inbound register.

17. The apparatus of claim 11, wherein said synchronous memory comprises a synchronous random access memory.

18. The apparatus of claim 11, wherein said synchronous memory comprises memory to store data from an inbound register.

19. A system, comprising:
a host;
a deep memory node coupled to said host; and
a physical layer device coupled to said deep memory node.

20. The system of claim 19, wherein said host comprises a host to initiate a large packet transaction.

21. The system of claim 19, wherein said deep-memory node comprises:
a synchronizer; and
a buffer coupled to said synchronizer; and
a synchronous memory coupled to said buffer.

22. The system of claim 19, wherein said deep-memory node comprises a synchronous memory to handle a large-packet transaction.

23. The system of claim 19, wherein said target device comprises a physical layer device to respond to a large-packet transaction.

24. A machine-readable medium containing instructions, which when executed by a machine, cause said machine to perform operations, comprising:
receiving a media clock signal;
creating a capture pulse to synchronize the media clock signal with a memory clock signal;
capturing media data at a transition of the capture pulse; and
storing the media data in a synchronous memory.

25. The machine-readable medium of claim 24 further comprising scheduling to store the media data in the synchronous memory.

26. The machine-readable medium of claim 24 further comprising multiplexing to store the media data in the synchronous memory.

27. The machine-readable medium of claim 24 wherein said creating a capture pulse to synchronize the media clock signal comprises creating a capture pulse with asynchronous logic.

28. The machine-readable medium of claim 24 wherein said creating a capture pulse to synchronize the media clock signal comprises creating a capture pulse to synchronize the media clock signal with a transition of the memory clock signal.

29. The machine-readable medium of claim 24 wherein said capturing data at a transition of the capture pulse comprises capturing data from a queue.

30. The machine-readable medium of claim 24 wherein said storing the data in a synchronous memory comprises writing a memory word to the synchronous memory.
